(19) United States
(12) Patent Application Publication
(10) Pub. No.: US 2006/0216219 A1
(43) Pub. Date: Sep. 28, 2006

(54) Aerogel monolith with improved strength

(76) Inventors: Kimberly A. DeFriend, Santa Fe, NM (US); Douglas A. Loy, Tuscon, AZ (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(21) Appl. No.: 11/385,141

(22) Filed: Mar. 20, 2006

Related U.S. Application Data
(60) Provisional application No. 60/664,664, filed on Mar. 22, 2005.

(51) Int. Cl. C01B 33/12

(52) U.S. Cl. 423/335

(57) ABSTRACT

Aerogel monoliths are treated with silanes or transition metal-containing reagents by chemical vapor deposition. This treatment improves the mechanical strength of the aerogel while maintaining their high surface area, low density, and porosity. When silane containing reagents are used, the transparency is generally maintained.

### RELATED CASES

This application claims the benefit of U.S. Provisional Patent Application Ser. No. 60/664,664 entitled “Aerogel Monolith With Improved Strength,” filed on Mar. 22, 2005, incorporated by reference herein.

### STATEMENT REGARDING FEDERAL RIGHTS

This invention was made with government support under Contract No. W-7405-ENG-36 awarded by the U.S. Department of Energy. The government has certain rights in the invention.

### FIELD OF THE INVENTION

The present invention relates generally to aerogels and more particularly to improving the mechanical strength of an aerogel monolith by diffusing a metal-containing, or silicon containing, reagent into the monolith.

### BACKGROUND OF THE INVENTION

Aerogel monoliths are brittle, porous, transparent materials with high surface areas. They are used commercially in particle detectors, particulate capturing agents, insulating materials, encapsulating agents, catalyst supports, and in other important applications.

An aerogel is prepared by removing solvent from a gel under supercritical conditions. The aerogel can then be treated to further modify its properties. U.S. Pat. No. 6,740,416 to Hiroshi Yokogawa et al. entitled “Aerogel Substrate and Method for Preparing the Same,” describes forming a hydrophobic coating on the surface of an aerogel layer by exposing the surface to silane reagents.

U.S. Pat. No. 4,478,987 to Anthony J. Fanelli et al. entitled “Alumina-Based Aerogel Supported Transition Metal Catalyst Useful as a Ziegler-Natta Olefin Polymerization Catalyst and the Process for Making the Same,” describes forming an olefin polymerization catalyst by calcinations of an alumina-based aerogel at elevated temperature (400-700 degrees Celsius) followed by treatment with a solution of TiCl₄.

E. Mitura et al. in “The Properties of Diamond-Like Carbon Layers Deposited Onto SiO₂ Aerogel,” Diamond and Related Materials, vol. 3, (1994), pp. 868-870, reported forming a diamond-like carbon coating on the surface of a silica based aerogel. According to Mitura et al., the coating improved the mechanical strength of the aerogel. Mari-Ann Einarsrud et al. in Journal of Non-Crystalline Solids, vol. 285, (2001), pp. 1-7, also reported a process for improving the strength of silica aerogels that involves washing and aging.

Aerogel monoliths are extremely fragile and their poor mechanical strength and fragility make them unsuitable for applications where they are subjected to pressure or mechanical stress.

There remains a need for methods that improve the strength of aerogel monoliths.

Accordingly, it is an object of this invention to provide a method for improving the strength of an aerogel monolith.

Another object of the present invention is to provide a method that improves the strength of an aerogel monolith without substantially changing the optical transparency of the monolith.

Another object of this invention is to provide an optically transparent aerogel monolith having improved mechanical strength.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

In accordance with the purposes of the present invention, as embodied and broadly described herein, the present invention includes a method for increasing the strength of an aerogel monolith. The method involves diffusing a silane or transition metal containing reagent into an aerogel monolith by chemical vapor deposition.

The invention also includes a transparent aerogel monolith prepared by a method comprising diffusing a reagent comprising a silane containing or transition metal-containing reagent into a precursor aerogel monolith by chemical vapor deposition.

The invention also includes a transparent aerogel monolith having a Young's modulus of from about 3 MPa to about 9 MPa.

### DETAILED DESCRIPTION

This invention is concerned with improving the mechanical strength of aerogel monoliths using silane or transition metal containing reagents. The silane reagents used with the invention substantially penetrate the monolith, while the transition metal reagents penetrate only a short distance from the surface of the monolith because they react very fast with reactive surface hydroxyl groups. The result is a monolith with improved mechanical strength, but with substantially the same density, porosity, surface area and optical transparency of the original untreated precursor aerogel monolith.

The invention involves exposing the monoliths to gaseous silane and metal containing reagents by a process known in the art as chemical vapor deposition. Chemical vapor deposition (CVD) is widely used for synthesizing materials, thin films, coatings, membranes, ceramic and metal powders, fibers, monoliths, semiconductors, and catalysts, and for microelectronics and optical devices. CVD is also known in the art by other names such as metal-organic chemical vapor deposition (MOCVD), low-pressure CVD, high-pressure CVD, molecular infiltration, chemical treatment, gas phase deposition, and chemical vapor infiltration.

Silica-based aerogel monoliths were used to demonstrate the invention. These monoliths were synthesized from an alkoxysilane (tetramethoxysilane (TMOS) for example) or from a hybrid organic/inorganic silsesquioxane monomer through sol-gel polymerization reaction. During the sol-gel polymerization reaction, monomeric precursor is hydrolyzed to produce a condensed alcogel. The alcogel is supercritically dried in liquid CO₂ to form the aerogel. There are hydroxyl functional groups are present on the surface of the aerogel due to incomplete condensation. These hydroxyl groups are chemically reactive with a variety of gas phase silane reagents and transition metal reagents. This invention utilizes these reactive hydroxyl groups that are produced during sol-gel polymerization to modify the aerogel by chemical vapor deposition. In a typical preparation, a sample of aerogel is weighed, placed in a reaction vessel, and exposed to a reactive, volatile molecular precursor under a static vacuum at room temperature for a period of from about 6 hours to about 48 hours. Afterward, the aerogel is removed from the reaction vessel and weighed to determine the amount of deposition.

The increase in the weight of the precursor monolith aerogel following exposure to the volatile molecular precursor generally depends on the density of the precursor monolith aerogel. Silica-based aerogels used for demonstrating this invention had densities in the range from about 30 mg/cc to about 290 mg/cc.

The optical transparency of the aerogel monolith after treatment is substantially the same as the precursor monolith when the exposure to the volatile molecular precursor is less than about 48 hours. If the reaction is allowed to proceed for longer periods of time (weeks in the case of silane reagents), then the product loses transparency. The invention is especially concerned with periods of exposure that do not substantially affect the transparency of the monolith.

The hydroxyl groups present on the surface of the aerogel monolith can react with many volatile and reactive molecular precursors over a range of temperatures, pressures and exposure times with densities that range from 1 mg/cc to 1 g/cc. The temperature, pressure, time of exposure, and the density of the monolith may be chosen to control the amount of deposition and strength enhancement of the aerogel monolith.

According to this invention, a wide variety of materials may be deposited onto an aerogel monolith to improve the strength of the monolith. Some of the reagents include main group elements, transition metals, lanthanides, actinides, and rare earth elements. Precursors may include a mixture of reactive groups, chemically inert sites, and inert (or reactive) bridging groups.

The reagent includes reactive groups that react with surface hydroxyl groups from the aerogel, enabling a portion of the reagent (a silicon portion or metal portion, for example) to deposit onto the aerogel surface. Reagents may also include groups that do not react with the surface hydroxyl groups. Inert groups in the case of silicon based reagents include, but are not limited to, hydrocarbyl groups such as alkyl, alkenyl, alkynyl, vinyl, aryl, or any other functional group that cannot react with uncondensed Si—OH to form Si—O-M bonds. Reagents may also include bridging groups that link one or more sites to other sites in the reagent.

In general, reactive groups are groups that react with the aerogel monolith to form one or more chemical bonds. In the case of silicon-based reagents, for example, some of the many possible reactive functional groups include, but are not limited to, halides, hydrides, amines, and alkoxides. Examples of silanes with hydride functional groups include SiH₄, CH₃SiH₃, CH₃SiH₂Cl, SiH₃SiH₃, CH₃SiH₂SiH₂CH₃. Examples of silanes with chloro functional groups include SiCl₄, Cl₃SiH, CH₃SiCl₃, and CH₂═CHSiCl₃, SiCl₃SiCl₃ and CH₃SiCl₂SiCl₂CH₃. Examples of silanes with alkoxy functional groups include HSi(OCH₃)₃, HSi(OCH₂CH₃)₃, Si(OCH₃)₄, and Si(OCH₃)₄. Some examples of organic bridged reactive silanes include Cl₃SiCH₂SiCl₃, Cl₃SiCH₂CH₂SiCl₃, Cl₃SiCCSiCl₃, and Cl₃SiCH═CHSiCl₃. These silanes and others like them may be used as reagents according to this invention for improving the mechanical strength of aerogel monoliths.

The present invention is more particularly described in the following EXAMPLES.

### EXAMPLE 1

Preparation of bridged aerogel. A solution of purified 1,6-bis(trimethoxysilyl)hexane (1.304 g, 4.0×10⁻³ mol) in methanol (3.72 ml) was prepared in a 30 ml polypropylene jar. A separate solution of aqueous catalyst (10.8 mol percent, 1N NaOH) with 6 equivalents of deionized water, and methanol (4.14 ml) was prepared in a scintillation vial (total volume 5 ml). The aqueous catalyst solution was quickly added to the monomer solution. A wet gel formed within 20 minutes. The wet-gel was allowed to age for 2 months. The aged wet-gel was removed from the polypropylene jar and placed in a 10 degrees Celsius autoclave (POLARON®) filled approximately half way (200 ml) with methanol. Liquid CO₂ was then added to fill the autoclave. The methanol in the gel was allowed to exchange with liquid CO₂ for 6 hours before the methanol was drained from the autoclave (12 hours) with liquid CO₂ continuously supplied to the autoclave. The gel was then supercritically dried at 40 degrees Celsius and 1300 psi for 6 hours to form the aerogel. The aerogel was a puck-shaped monolith having a diameter of about 30 millimeters (mm) in diameter and about 9 mm in width. The density of the aerogel was gravimetrically calculated to be 290 mg/cc.

Aerogels having densities lower than 290 mg/cc were also prepared by using less monomer while adjusting the amount of sodium hydroxide, deionized water, and methanol.

An aerogel having a density of about 130 mg/cc was prepared by a similar procedure, with the exception that the solution of bridged monomer included 0.652 g of monomer in 4.35 ml methanol, and the aqueous catalyst solution included 10.8 mol percent of monomer but with 4.568 ml of methanol.

An aerogel having a density of about 79 mg/cc was also prepared by a similar procedure, with the exception that the solution of bridged monomer included 0.326 g of bridged monomer in 4.68 ml methanol, and the aqueous catalyst solution also included 10.8 mol percent of monomer but with 4.784 ml methanol.

Compression testing was performed on each of the three unbridged precursor monoliths. The results of the compression testing are summarized in TABLE 1 below.

TABLE 1

| Monolith | Density (mg/cc) | Young's modulus (MPa) |
|---|---|---|
| 1 | 290 | 1.6 |
| 2 | 130 | 0.53 |
| 3 | 79 | 0.25 |

### EXAMPLE 2

Preparation of a set of invention monoliths from bridged aerogel. Five aerogel monoliths having density of 290 mg/cc were prepared according to EXAMPLE 1. Each one was placed into a vessel and exposed to hexamethyldisilazane (HMDS) at room temperature under a static vacuum (500 mtorr) and atmospheric pressure. After a reaction time of about 48 hours, each invention monolith was removed from the reaction vessel and weighed to determine the amount of reaction. TABLE 2 shows the weight in grams of the starting aerogel monolith and the weight after exposure to HMDS.

TABLE 2

| | | |
|---|---|---|
| Monolith | Before exposure | After exposure |

| | | | | |
|---|---|---|---|---|
| 4 | 0.814 | g | 1.04 | g |
| 5 | 0.79 | g | 1.0106 | g |
| 6 | 0.79 | g | 1.01 | g |
| 7 | 0.797 | g | 1.028 | g |
| 8 | 0.810 | g | 1.028 | g |

There did not appear to be any substantial change in the optical transparency of any of the invention monoliths compared to the initial untreated aerogel monoliths.

Compression testing was performed on the invention monolith. A comparison of the results from the compression testing of the treated monoliths with that for the precursor monoliths is shown in TABLE 3.

TABLE 3

| | | Density after | Young's modulus | Young's Modulus |
|---|---|---|---|---|
| Precursor | Density before | HMDS treatment | before treatment | after treatment |
| monolith | treatment (mg/cc) | (mg/cc) | (MPa) | (MPa) |
| 1 | 290 | 370 | 1.6 | 3.1 |
| 2 | 130 | 150 | 0.53 | 0.86 |
| 3 | 79 | 125 | 0.25 | 1.19 |

### EXAMPLE 3

Preparation of a second set of invention from bridged aerogel monoliths. Five aerogel monoliths having a density of 290 mg/cc were prepared according to EXAMPLE 1. Each one was placed into a vessel and exposed to hexachlorodisilane at a temperature of about 60° C. under a static vacuum (500 mtorr) and atmospheric pressure. After a reaction time of about 6 hours, the invention monolith was removed from the reaction vessel and weighed to determine the amount of reaction. TABLE 4 shows the weight in grams of each starting aerogel monolith and the weight after exposure to hexachlorodisilane.

TABLE 4

| Monolith | Before | After |
|---|---|---|
| 9 | 0.768 g | 0.792 g |
| 10 | 0.773 g | 0.801 g |
| 11 | 0.788 g | 0.807 g |
| 12 | 0.765 g | 0.786 g |
| 13 | 0.803 g | 0.860 g |

There was no apparent change in the optical transparency of any of the invention monoliths compared to the untreated aerogel monoliths.

Compression testing was performed on the invention monolith. A comparison of the results from the compression testing of the treated monolith with that for the precursor monolith is shown in TABLE 5.

TABLE 5

| | | Density after | Young's modulus | Young's Modulus |
|---|---|---|---|---|
| Precursor | Density before | HMDS treatment | before treatment | after treatment |
| monolith | treatment (mg/cc) | (mg/cc) | (MPa) | (MPa) |
| 1 | 290 | 370 | 1.6 | 3.1 |

TABLE 6 compares the properties of the untreated bridged monolith (EXAMPLE 1) with the monoliths prepared according to EXAMPLE 2 (treated with HMDS and EXAMPLE 3 (treated with hexachlorodisilane).

TABLE 6

| | Surface | Pore | Pore | | Young's |
|---|---|---|---|---|---|
| | area | volume | diameter | Density | modulus |
| Monolith | (m²/g) | (cc/g) | (Å) | (mg/cc) | (MPa) |
| (1) | 800 | 1.58 | 79 | 290 | 1.6 |
| Aerogel monolith | 770 | 1.64 | 85 | 370 | 3.1 |
| (1), 290 mg/cc, | | | | | |
| treated with HMDS | | | | | |
| Aerogel monolith | 748 | 3.03 | 165 | 300 | 9.0 |
| (1), 290 mg/cc, | | | | | |
| treated with | | | | | |
| hexachlorodisilane | | | | | |

As TABLE 6 shows, the invention monolith produced using hexamethyldisilazane had twice the compressive strength (Young's modulus) as the precursor monolith. The invention monolith produced using hexachlorodisilane had six times the compressive strength as the precursor monolith. There appeared to be only small changes in the surface area and density after treatment by chemical vapor deposition.

### EXAMPLE 4

Preparation of unbridged aerogel. Purified tetramethoxysilane (TMOS) (1.0×10⁻² mol) was weighed into a 30 ml polypropylene jar. The weighed monomer was dissolved in enough methanol (3.5 ml) to bring the monomer solution volume to 5 ml.

An aqueous catalyst solution (5 ml) was also prepared by combining aqueous catalyst (7.2 mol percent of monomer, 1N NH₄OH), 4 equivalents of deionized (DI) water, and methanol (3.6 ml). The aqueous catalyst solution was added quickly to the monomer solution. A wet gel formed within 5 minutes. The wet gel was allowed to age for 2 months. After two months of aging, the aged wet-gel was removed from the polypropylene jar and placed in a 10 degrees Celsius autoclave (POLARON®) filled approximately half way (200 ml) of methanol. Liquid CO₂ was then added to fill the autoclave. The methanol in the gel was allowed to exchange with liquid CO₂ for 6 hours before the methanol was drained from the autoclave (12 hours) with liquid CO₂ continuously supplied to the autoclave. The gel was then super-critically dried at 40 degrees Celsius and 1300 psi for 6 hours to form the aerogel. The density of the aerogel was gravimetrically calculated to be 92 mg/cc. The puck shaped aerogel monolith was about 30 mm in diameter and about 9 mm in height.

Aerogels having a lower density may be prepared using less monomer and adjusting the amount of base, deionized water, and methanol.

Accordingly, another unbridged aerogel monolith having a density of about 47.5 mg/cc was prepared by a similar procedure with the exception that the solution of monomer contained 0.6088 g TMOS in 4.41 ml methanol, and the catalyst solution was prepared also using 7.2 mol percent of monomer but with 4.424 ml methanol (the total volume was still 10 ml).

### EXAMPLE 5

Preparation a set of monoliths from unbridged aerogel. Four unbridged aerogel monoliths were prepared according to EXAMPLE 4. Each was placed into a separate reaction vessel and exposed to hexamethyldisilazane (HMDS) at room temperature under a static vacuum (500 mtorr) and atmospheric pressure. After a reaction time of about 48 hours, the invention monolith was removed from the reaction vessel and weighed to determine the amount of reaction. TABLE 7 shows the weight in grams of each starting aerogel monolith and the weight after exposure to HMDS.

TABLE 7

| Monolith | Before | After |
|---|---|---|
| 14 | 0.675 | 0.772 |
| 15 | 0.560 | 0.644 |
| 16 | 0.620 | 0.719 |
| 17 | 0.591 | 0.689 |

There was not apparent change in the optical transparency in any of the treated aerogel monoliths compared to the corresponding untreated monoliths.

Compression testing was performed on the unbridged treated aerogel monoliths.

TABLE 8 provides a comparison of the density of the untreated unbridged monolith with the treated unbridged monolith.

TABLE 8

| | | Density after | Young's modulus | Young's Modulus |
|---|---|---|---|---|
| | Density before | HMDS treatment | before treatment | after treatment |
| Monolith | treatment (mg/cc) | (mg/cc) | (MPa) | (MPa) |
| Unbridged | 92 | 100 | 0.26 | 0.68 |
| monolith | | | | |
| Unbridged | 47.5 | 76.5 | 0.15 | 0.55 |
| monolith | | | | |

TABLE 9 provides a comparison of the density and Young's modulus of bridged aerogel monoliths of EXAMPLE 2 and unbridged, TMOS derived aerogel monoliths of EXAMPLE 5 before and hexamethyldisilazane (HMDS) treatment.

TABLE 9

| | | Density after | Young's modulus | Young's Modulus |
|---|---|---|---|---|
| | Density before | HMDS treatment | before treatment | after HMDS |
| Monolith | treatment (mg/cc) | (mg/cc) | (MPa) | treatment (MPa) |
| Bridged aerogel | 290 | 370 | 1.6 | 3.1 |
| monolith | | | | |
| Bridged aerogel | 130 | 150 | 0.53 | 0.86 |
| monolith | | | | |
| Bridged aerogel | 79 | 125 | 0.25 | 1.19 |
| monolith | | | | |
| Unbridged | 92 | 100 | 0.26 | 0.68 |
| monolith | | | | |
| Unbridged | 47.5 | 76.5 | 0.15 | 0.55 |
| monolith | | | | |

The numbers in TABLE 9 appear to indicate a larger increase in the Young's modulus for the lower density samples.

Changes in the physical properties of the aerogel after treatment were also examined using infrared (IR) spectroscopy, Cross Polarization Magic Angle Spinning (CP-MAS) Nuclear Magnetic Resonance (NMR) Spectroscopy (²⁹Si, and ¹³C), scanning electron microscopy (SEM).

It should be understood that the use of silica-based aerogels was for demonstration purposes only, and that other types of aerogels that include, but are not limited to, alumina aerogels [1-3], main group metal oxide aerogels [4-5], carbonaceous aerogels [6-9], resorcinol-formaldehyde aerogels [10-12], transition metal oxide aerogels [13-16], and mixed metal oxide aerogels [17-18] may also be used with this invention.

The applications that could benefit from increasing the strength of an aerogel according to this invention include catalysts, catalyst supports, adsorbents, thermal insulation and acoustic insulation. The largest of these markets is the catalyst market, where applications are wide ranging and include fuel cells, pollution control, and chemical processing. Currently, aerogels make up only a small fraction of the catalyst market, but there is significant potential for catalyst development because these catalysts have the highest surface area per unit mass and per unit volume of any known material; in addition, they possess chemical and temperature stability.

Aerogels having improved strength prepared according to this invention could also be used in architectural applications that exploit the thermal insulation and acoustic insulation properties as well as diffusive light characteristics. Aerogels may provide diffuse interior lighting while maintaining excellent thermal insulation. Currently these applications are limited by the cost of synthesizing the aerogel and the poor mechanical strength. The present invention converts a typical brittle precursor aerogel monolith into a more useful, higher strength monolith.

The foregoing description of the invention has been presented for purposes of illustration and description and is not intended to be exhaustive or to limit the invention to the precise form disclosed, and obviously many modifications and variations are possible in light of the above teaching. For example, puck-shaped aerogel monoliths were prepared specifically so that compression testing may be easily performed on both untreated and treated aerogel monoliths. However, it should be understood that an aerogel monolith having any shape and size may be treated according to this invention for improving its strength and mechanical properties.

The embodiment(s) were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

### REFERENCES

The following references are incorporated by reference herein.

[1] J. F. Poco; J. H. Satcher, and L. W. Hrubesh, Journal of Non-Crystalline Solids, vol. 285 (2001) pp. 57-63.
[2] Y. Mizushima and M. Hori, Journal of Non-Crystalline Solids, vol. 167 (1994) pp. 1-8.
[3] Y. Mizushima and M. Hori, Journal of the European Ceramic Society, vol. 14 (1994) pp 117-121.
[4] A. E. Gash; T. M. Tillotson; J. H. Satcher; L. W. Hrubesh and R. L. Simpson, Journal of Non-Crystalline Solids, vol. 285 (2001) pp. 22-28.
[5] Z. S. Hu; L. G. Wang; Z. W. Ou; L. Huang; R. Lai; T. He; J. X. Dong, and G. X. Chen, Powder Technology, vol. 114 (2001) pp. 163-167.
[6] C. I. Merzbacher; S. R. Meier; J. R. Pierce, and M. L. Korwin, Journal of Non-Crystalline Solids, vol. 285 (2001) pp. 210-215.
[7] R. Saliger; U. Fischer; C. Herta, and J. Fricke, Journal of Non-Crystalline Solids, vol. 225 (1998) pp. 81-85.
[8] R. W. Pekala, J. C. Farmer; C. T. Alviso; T. D. Tran; S. T. Mayer; J. M. Miller, and B. Dunn, Journal of Non-Crystalline Solids, vol. 225 (1998) pp. 74-80.
[9] R. W. Fu; Y. M. Lin; O. Rabin; G. Gresselhaus; M. S. Dresselhaus; J. H. Satcher, and T. F. Baumann, Journal of Non-Crystalline Solids, vol. 317 (2003) pp. 247-253.
[10] D. W. Schaefer; R. Pekala, and G. Beaucage, Journal of Non-Crystalline Solids, vol. 186 (1995) pp. 159-167.
[11] V. Bock; A. Emmerling, and J. Fricke, Journal of Non-Crystalline Solids, vol. 225 (1998) pp. 69-73.
[12] C. H. Liang; G. Y. Sha, and S. C. Guo, Journal of Non-Crystalline Solids, vol. 271 (2000) pp. 167-170.
[13] S. M. Maurer; D. Ng, and E. I. Ko, Catalysis Today, vol. 16 (1993) pp. 319-331.
[14] J. B. Miller; S. T. Johnston, and E. I. Ko, Journal of Catalysis, vol. 150 (1994) pp. 311-320.
[15] D. C. Dutoit; U. Gobel; M. Schneider, and A. Baiker, Journal of Catalysis, vol. 164 (1996) pp. 433-439.
[16] J. B. Miller; S. E. Rankin, and E. I. Ko, Journal of Catalysis, vol. 148 (1994) pp. 673-682.
[17] L. M. Hair; L. Owens; T. Tillotson; M. Froba; J. Wong; G. J. Thomas, and D. L. Medlin, Journal of Non-Crystalline Solids, vol. 186 (1995) pp. 168-176.
[18] L. M. Hair; P. R. Coronado, and J. G. Reynolds, Journal of Non-Crystalline Solids, vol. 270 (2000) pp. 115-122.

What is claimed is:

1. A method for increasing the strength of an aerogel monolith comprising diffusing a gaseous reagent comprising a silane-containing or transition metal-containing reagent into a precursor aerogel monolith by chemical vapor deposition.

2. The method of claim 1, wherein the aerogel comprises a silica-based aerogel, a main group metal oxide-based aerogel, a carbonaceous aerogel, a resorcinol-formaldehyde-based aerogel, a transition metal oxide-based aerogel, or a mixed metal oxide-based aerogel.

3. The method of claim 1, wherein the reagent comprises at least one halide, hydride, amine, alkoxide, alkyl, alkenyl, alkynyl, vinyl, aryl, or combinations thereof.

4. The method of claim 1, wherein the reagent comprises a functional group that cannot react with uncondensed Si—OH to form Si—O-M bonds or a bridging group.

5. The method of claim 1, wherein the silane reagent is selected from the group consisting of SiH₄, CH₃SiH₃, CH₃SiH₂Cl, SiH₃SiH₃, CH₃SiH₂SiH₂CH₃, SiCl₄, Cl₃SiH, CH₃SiCl₃, CH₂═CHSiCl₃, SiCl₃SiCl₃, CH₃SiCl₂SiCl₂CH₃, HSi(OCH₃)₃, HSi(OCH₂CH₃)₃, Si(OCH₃)₄, Si(OCH₃)₄, Cl₃SiCH₂SiCl₃, Cl₃SiCH₂CH₂SiCl₃, Cl₃SiCCSiCl₃, Cl₃SiCH═CHSiCl₃, and hexamethyldisilazane,

6. The method of claim 1, wherein the metal-containing reagent comprises a main group element, a transition metal element, a lanthanide element, an actinide element, a rare earth element, or combinations thereof.

7. The method of claim 1, wherein the reagent diffuses substantially throughout the monolith.

8. The method of claim 1, wherein the transparency of the monolith is substantially unchanged after diffusing the reagent into the monolith.

9. The method of claim 1, wherein the aerogel is exposed to reagent for a period of from about 6 hours to about 48 hours.

10. The method of claim 1, wherein the aerogel prior to exposure to the reagent comprises a density of from about 30 mg/cc to about 290 mg/cc.

11. A transparent aerogel monolith prepared by a method comprising diffusing a gaseous reagent comprising a silane-containing or transition metal-containing reagent into a precursor aerogel monolith by chemical vapor deposition.

12. The transparent aerogel monolith of claim 11, wherein the method of claim 1, wherein the precursor aerogel monolith comprises a silica-based aerogel, a main group metal oxide-based aerogel, a carbonaceous aerogel, a resorcinol-formaldehyde-based aerogel, a transition metal oxide-based aerogel, or a mixed metal oxide-based aerogel.

13. The transparent aerogel monolith of claim 11, wherein the reagent comprises at least one halide, hydride, amine, alkoxide, alkyl, alkenyl, alkynyl, vinyl, aryl, or combinations thereof.

14. The transparent aerogel monolith of claim 11, wherein the reagent comprises a functional group that cannot react with uncondensed Si—OH to form Si—O-M bonds or a bridging group.

15. The transparent aerogel monolith of claim 11, wherein the silane reagent is selected from the group consisting of SiH₄, CH₃SiH₃, CH₃SiH₂Cl, SiH₃SiH₃, CH₃SiH₂SiH₂CH₃, SiCl₄, Cl₃SiH, CH₃SiCl₃, CH₂═CHSiCl₃, SiCl₃SiCl₃, CH₃SiCl₂SiCl₂CH₃, HSi(OCH₃)₃, HSi(OCH₂CH₃)₃, Si(OCH₃)₄, Si(OCH₃)₄, Cl₃SiCH₂SiCl₃, Cl₃SiCH₂CH₂SiCl₃, Cl₃SiCCSiCl₃, Cl₃SiCH═CHSiCl₃, and hexamethyldisilazane,

16. The transparent aerogel monolith of claim 11, wherein the metal-containing reagent comprises a main group element, a transition metal element, a lanthanide element, an actinide element, a rare earth element, or combinations thereof

17. The transparent aerogel monolith of claim 11, wherein the reagent diffuses substantially throughout the monolith.

18. The transparent aerogel monolith of claim 11, wherein the transparency of the monolith is substantially unchanged after diffusing the reagent into the monolith.

19. The transparent aerogel monolith of claim 11, wherein the aerogel is exposed to reagent for a period of from about 6 hours to about 48 hours.

20. The transparent aerogel monolith of claim 11, wherein the aerogel prior to exposure to the reagent comprises a density of from about 30 mg/cc to about 290 mg/cc.

21. A transparent aerogel monolith comprising a Young's modulus of from about 3 MPa to about 9 MPa.
